(19) United States
(12) Patent Application Publication
(10) Pub. No.: US 2008/0141320 A1
(43) Pub. Date: Jun. 12, 2008

(54) System and method of providing public video content

(75) Inventors: Mary McCarthy, San Antonio, TX (US); Anthony A. Haeuser, Aurora, IL (US); Valerie H. Montalvo, San Antonio, TX (US); Roland Noll, San Antonio, TX (US)

Correspondence Address: TOLER LAW GROUP, 8500 BLUFFSTONE COVE, SUITE A201, AUSTIN, TX, 78759, US

(73) Assignee: SBC Knowledge Ventures, LP, Reno, NV (US)

(21) Appl. No.: 11/635,392

(22) Filed: Dec. 7, 2006

(51) Int. Cl. H04N 7/173

(52) U.S. Cl. 725/110

(57) ABSTRACT

Disclosed is a system and method of providing public video content. The method includes receiving video content of a public video content channel at a set-top box device via a private access network of a video distribution system, where the video content is accessible to the video distribution system via a web page associated with the public video content channel.

### FIELD OF THE DISCLOSURE

The present disclosure relates generally to providing public video content.

### BACKGROUND

Television viewing is a part of daily life for many people. Thus, television provides an avenue for government, education and other public institutions and services to convey information to particular communities. Typically, live video feeds are sent from a studio or other site directly to a broadcast station or cable head-end office and are then delivered to viewers via one or more Public Education and Government (PEG) channels or other publicly generated content sources. As technologies other than broadcast and cable television are implemented to deliver video content, it can be inefficient and costly to build separate studios or other sites to communicate with new delivery platforms. Moreover, current delivery systems typically do not provide interactive information related to video content provided via PEG channels or similar channels. Hence, there is a need for an enhanced system and method of providing public video content.

### BRIEF DESCRIPTION OF THE DRAWINGS

FIG. 1 is a block diagram of a particular illustrative embodiment of a system to provide public video content;

FIG. 2 is a block diagram of a second particular illustrative embodiment of a system to provide public video content;

FIG. 3 is a flow diagram of a particular illustrative embodiment of a method of providing public video content;

FIG. 4 is a flow diagram of a second particular illustrative embodiment of a method of providing public video content;

FIG. 5 is a flow diagram of a third particular illustrative embodiment of a method of providing public video content

FIG. 6 is a diagram of a particular illustrative embodiment of an application interface to provide public video content; and

FIG. 7 is a diagram of an illustrative embodiment of a general computer system.

### DETAILED DESCRIPTION OF THE DRAWINGS

The present disclosure is generally directed to a system and method of providing public video content. In a particular embodiment, a set-top box device is disclosed that includes a processor and a memory device accessible to the processor. The memory device stores instructions executable by the processor to communicate with a private access network of an Internet Protocol Television (IPTV) system to receive video content of a public video content channel, where the video content is accessible to the IPTV system via a web page associated with the public video content channel.

In another embodiment, the disclosure is directed to a method of providing public video content that includes receiving video content of a public video content channel at a set-top box device via a private access network of a video distribution system, where the video content is accessible to the video distribution system via a web page associated with the public video content channel.

In another embodiment, the disclosure is directed to a method of providing public video content that includes receiving data indicating a selection of a public video content channel from a set-top box device at a first server of an Internet Protocol Television (IPTV) system. The method also includes requesting video content of the public video content channel via a web page associated with the public video content channel, where the video content is communicated to the set-top box from the web page.

In another embodiment, the disclosure is directed to a method of providing public video content that includes receiving a uniform resource locator (URL) request at a web application server of an Internet Protocol Television (IPTV) system, the URL request including a URL of a web page associated with a public video content channel. The method also includes retrieving the web page via a public data network, where the video content of the public video content channel is targeted for communication from the web page to a set-top box device via a private access network of the IPTV system.

In another embodiment, the disclosure is directed to a computer-readable medium tangibly embodying instructions executable by a processor to receive a uniform resource locator (URL) request at a first device of a video distribution system, the URL request including a URL of a web page associated with a public video content channel. The instructions are also executable by the processor to retrieve the web page via a public data network, where the video content of the public video content channel is communicated from the web page to a set-top box device via a private access network of the video distribution system. In a particular embodiment, the instructions are executable by the processor to direct an Internet Mediation Device to send the video content to the set-top box device via a private access network of the video distribution system.

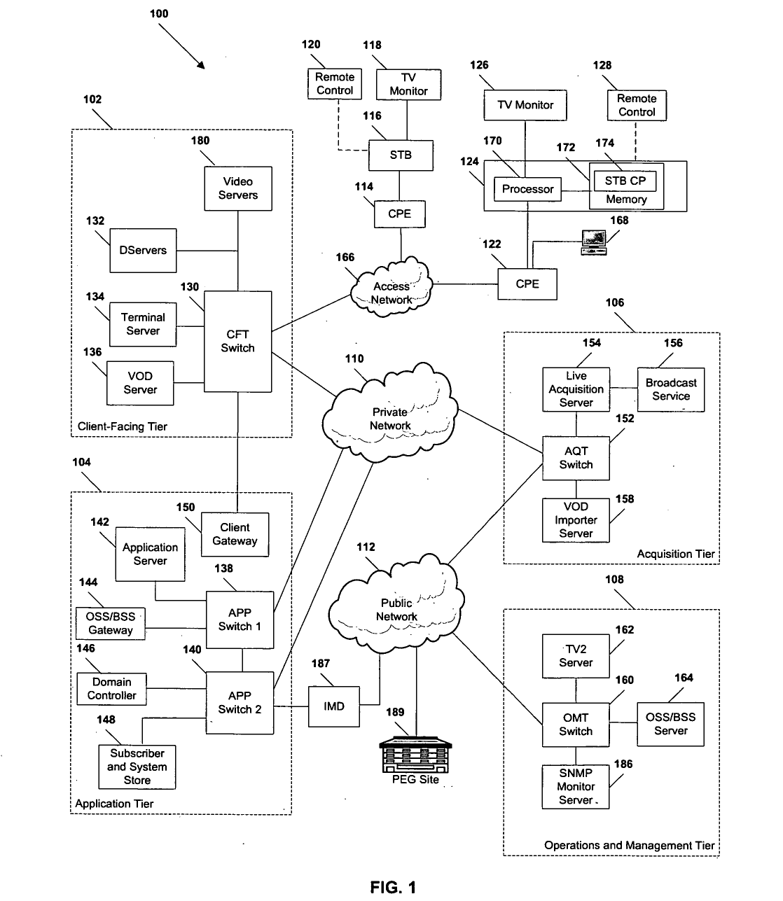

Referring to FIG. 1, an illustrative embodiment of an Internet Protocol Television (IPTV) system that can be used to provide public video content is illustrated and is generally designated 100. As shown, the system 100 can include a client facing tier 102, an application tier 104, an acquisition tier 106, and an operations and management tier 108. Each tier 102, 104, 106, 108 is coupled to a private network 110; to a public network 112, such as the Internet; or to both the private network 110 and the public network 112. For example, the client-facing tier 102 can be coupled to the private network 110. Further, the application tier 104 can be coupled to the private network 110 and to the public network 112. The acquisition tier 106 can also be coupled to the private network 110 and to the public network 112. Additionally, the operations and management tier 108 can be coupled to the public network 112.

As illustrated in FIG. 1, the various tiers 102, 104, 106, 108 communicate with each other via the private network 110 and the public network 112. For instance, the client-facing tier 102 can communicate with the application tier 104 and the acquisition tier 106 via the private network 110. The application tier 104 can communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104, including, but not limited to, a client gateway 150, can communicate directly with the client-facing tier 102.

The client-facing tier 102 can communicate with user equipment via an access network 166, such as a private IPTV access network. In an illustrative embodiment, customer premises equipment (CPE) 114, 122 can be coupled to a digital subscriber line access multiplexer (DSLAM), service area interface (SAI), edge device, video distribution hub, other device, or any combination thereof, of the access network 166. The client-facing tier 102 can communicate with a first representative set-top box device 116 via the first CPE 114 and with a second representative set-top box device 124 via the second CPE 122. In a particular embodiment, the first representative set-top box device 116 and the first CPE 114 can be located at a first customer premise, and the second representative set-top box device 124 and the second CPE 122 can be located at a second customer premise. In another particular embodiment, the first representative set-top box device 116 and the second representative set-top box device 124 can be located at a single customer premise, both coupled to one of the CPE 114, 122. The CPE 114, 122 can include routers, local area network elements, modems, such as digital subscriber line (DSL) modems, any other suitable devices for facilitating communication between a set-top box device and the access network 166, or any combination thereof.

In an exemplary embodiment, the client-facing tier 102 can be coupled to the CPE 114, 122 via fiber optic cables. In another exemplary embodiment, the CPE 114, 122 can be digital subscriber line (DSL) modems that are coupled to one or more network nodes via twisted pairs, and the client-facing tier 102 can be coupled to the network nodes via fiber-optic cables. Each set-top box device 116, 124 can process data received via the access network 166, via an IPTV software platform, such as Microsoft® TV IPTV Edition.

The first set-top box device 116 can be coupled to a first external display device, such as a first television monitor 118, and the second set-top box device 124 can be coupled to a second external display device, such as a second television monitor 126. Moreover, the first set-top box device 116 can communicate with a first remote control device 120, and the second set-top box device 124 can communicate with a second remote control device 128. The set-top box devices 116, 124 can include IPTV set-top box devices; video gaming devices or consoles that are adapted to receive IPTV content; personal computers or other computing devices that are adapted to emulate set-top box device functionalities; any other device adapted to receive IPTV content and transmit data to an IPTV system via an access network; or any combination thereof.

In an exemplary, non-limiting embodiment, each set-top box device 116, 124 can receive data, video, or any combination thereof, from the client-facing tier 102 via the access network 166 and render or display the data, video, or any combination thereof, at the display device 118, 126 to which it is coupled. In an illustrative embodiment, the set-top box devices 116, 124 can include tuners that receive and decode television programming signals or packet streams for transmission to the display devices 118, 126. Further, each of the set-top box devices 116, 124 can include a processor and a memory device accessible to the processor, such as the STB processor 170 and the STB memory device 172. In one embodiment, a computer program, such as the STB computer program 174, can be embedded within the STB memory device 172.

In an illustrative embodiment, the client-facing tier 102 can include a client-facing tier (CFT) switch 130 that manages communication between the client-facing tier 102 and the access network 166 and between the client-facing tier 102 and the private network 110. As illustrated, the CFT switch 130 is coupled to one or more data servers, such as D-servers 132, that store, format, encode, replicate, or otherwise manipulate or prepare video content for communication from the client-facing tier 102 to the set-top box devices 116, 124. The CFT switch 130 can also be coupled to a terminal server 134 that provides terminal devices with a connection point to the private network 110. In an illustrative embodiment, the terminal server 134 can communicate with a web application server, such as the application server 142, to send URL requests that include uniform resource locators (URLs) of web pages corresponding to Public Education and Government (PEG) channels or other public content channels requested by users via the set-top box devices 116, 124. In a particular embodiment, the CFT switch 130 can be coupled to a video-on-demand (VOD) server 136 that stores and provides VOD content imported by the IPTV system 100. Further, the CFT switch 130 is coupled to one or more video servers 180 that receive video content and transmit the video content to the set-top boxes 116, 124 via the access network 166.

In an illustrative embodiment, the client-facing tier 102 can communicate with a large number of set-top boxes, such as the representative set-top boxes 116, 124 over a wide geographic area, such as a metropolitan area, a viewing area, a statewide area, a regional area, a nationwide area or any other suitable geographic area, market area, or subscriber or customer group that can be supported by networking the client-facing tier 102 to numerous set-top box devices. In a particular embodiment, the CFT switch 130, or any portion thereof, can include a multicast router or switch that communicates with multiple set-top box devices via a multicast-enabled network.

As illustrated in FIG. 1, the application tier 104 can communicate with both the private network 110 and the public network 112. The application tier 104 can include a first application tier (APP) switch 138 and a second APP switch 140. In a particular embodiment, the first APP switch 138 can be coupled to the second APP switch 140. The first APP switch 138 can be coupled to an application server 142 and to an OSS/BSS gateway 144. In a particular embodiment, the application server 142 can provide applications to the set-top box devices 116, 124 via the access network 166, which enable the set-top box devices 116, 124 to provide functions, such as interactive program guides, video gaming, display, messaging, processing of VOD material and other IPTV content, public content application interfaces, etc. In an illustrative embodiment, the application server 142 can be a web application server that communicates with the Internet via an Internet Mediation Device 187, one or more firewalls, or any combination thereof. In a particular embodiment, the OSS/BSS gateway 144 includes operation systems and support (OSS) data, as well as billing systems and support (BSS) data. In one embodiment, the OSS/BSS gateway 144 can provide or restrict access to an OSS/BSS server 164 that stores operations and billing systems data.

The second APP switch 140 can be coupled to a domain controller 146 that provides Internet access, for example, to users at their computers 168. For example, the domain controller 146 can provide Internet access to IPTV account information, e-mail, personalized Internet services, or other online services via the public network 112. In addition, the second APP switch 140 can be coupled to a subscriber and system store 148 that includes account information, such as account information that is associated with users who access the IPTV system 100 via the private network 110 or the public network 112. In an illustrative embodiment, the subscriber and system store 148 can store subscriber or customer data and create subscriber or customer profiles that are associated with IP addresses, stock-keeping unit (SKU) numbers, other identifiers, or any combination thereof, of corresponding set-top box devices 116, 124. In another illustrative embodiment, the subscriber and system store 148 can store data associated with capabilities of set-top box devices associated with particular customers.

In a particular embodiment, the application tier 104 can include a client gateway 150 that communicates data directly to the client-facing tier 102. In this embodiment, the client gateway 150 can be coupled directly to the CFT switch 130. The client gateway 150 can provide user access to the private network 110 and the tiers coupled thereto. In an illustrative embodiment, the set-top box devices 116, 124 can access the IPTV system 100 via the access network 166, using information received from the client gateway 150. User devices can access the client gateway 150 via the access network 166, and the client gateway 150 can allow such devices to access the private network 110 once the devices are authenticated or verified. Similarly, the client gateway 150 can prevent unauthorized devices, such as hacker computers or stolen set-top box devices from accessing the private network 110, by denying access to these devices beyond the access network 166.

For example, when the first representative set-top box device 116 accesses the client-facing tier 102 via the access network 166, the client gateway 150 can verify subscriber information by communicating with the subscriber and system store 148 via the private network 110. Further, the client gateway 150 can verify billing information and status by communicating with the OSS/BSS gateway 144 via the private network 110. In one embodiment, the OSS/BSS gateway 144 can transmit a query via the public network 112 to the OSS/BSS server 164. After the client gateway 150 confirms subscriber information, billing information, or any combination thereof, the client gateway 150 can allow the set-top box device 116 to access IPTV content, VOD content, other content, or any combination thereof, via the client-facing tier 102. If the client gateway 150 cannot verify subscriber information, billing information, or any combination thereof, for the set-top box device 116, e.g., because it is connected to an unauthorized twisted pair, the client gateway 150 can block transmissions to and from the set-top box device 116 beyond the access network 166.

As indicated in FIG. 1, the acquisition tier 106 includes an acquisition tier (AQT) switch 152 that communicates with the private network 110. The AQT switch 152 can also communicate with the operations and management tier 108 via the public network 112. In a particular embodiment, the AQT switch 152 can be coupled to a live acquisition server 154 that receives or acquires television content, movie content, advertisement content, other video content, or any combination thereof, from a broadcast service 156, such as a satellite acquisition system or satellite head-end office. In a particular embodiment, the live acquisition server 154 can transmit content to the AQT switch 152, and the AQT switch 152 can transmit the content to the CFT switch 130 via the private network 110.

In an illustrative embodiment, content can be transmitted to the D-servers 132, where it can be encoded, formatted, stored, replicated, or otherwise manipulated and prepared for communication from the video server(s) 180 to the set-top box devices 116, 124. The CFT switch 130 can receive content from the video server(s) 180 and communicate the content to the CPE 114, 122 via the access network 166. The set-top box devices 116, 124 can receive the content via the CPE 114, 122, and can transmit the content to the television monitors 118, 126. In an illustrative embodiment, video portions, audio portions, or any combination thereof, of the content can be streamed to the set-top box devices 116, 124.

Further, the AQT switch 152 can be coupled to a video-on-demand importer server 158 that receives and stores television or movie content received at the acquisition tier 106 and communicates the stored content to the VOD server 136 at the client-facing tier 102 via the private network 110. Additionally, at the acquisition tier 106, the video-on-demand (VOD) importer server 158 can receive content from one or more VOD sources outside the IPTV system 100, such as movie studios and programmers of non-live content via satellite, via stored media, via the public network 112, or any combination thereof. The VOD importer server 158 can transmit the VOD content to the AQT switch 152, and the AQT switch 152, in turn, can communicate the material to the CFT switch 130 via the private network 110. The VOD content can be stored at one or more servers, such as the VOD server 136.

When users issue requests for VOD content via the set-top box devices 116, 124, the requests can be transmitted over the access network 166 to the VOD server 136, via the CFT switch 130. Upon receiving such requests, the VOD server 136 can retrieve the requested VOD content and transmit the content to the set-top box devices 116,124 across the access network 166, via the CFT switch 130. The set-top box devices 116, 124 can transmit the VOD content to the television monitors 118, 126. In an illustrative embodiment, video or audio portions of VOD content can be streamed to the set-top box devices 116, 124.

FIG. 1 further illustrates that the operations and management tier 108 can include an operations and management tier (OMT) switch 160 that conducts communication between the operations and management tier 108 and the public network 112. In the embodiment illustrated by FIG. 1, the OMT switch 160 is coupled to a TV2 server 162. Additionally, the OMT switch 160 can be coupled to an OSS/BSS server 164 and to a simple network management protocol (SNMP) monitor 186 that monitors network elements within or coupled to the IPTV system 100. In a particular embodiment, the OMT switch 160 can communicate with the AQT switch 152 via the public network 112.

In an illustrative embodiment, the live acquisition server 154 can transmit content to the AQT switch 152, and the AQT switch 152, in turn, can transmit the content to the OMT switch 160 via the public network 112. In this embodiment, the OMT switch 160 can transmit the content to the TV2 server 162 for display to users accessing the user interface at the TV2 server 162. For example, a user can access the TV2 server 162 using a personal computer 168 communicating with the public network 112.

In a particular embodiment, a source of Public Education and Government (PEG) content, or other publicly generated content, such as the PEG site 189, is coupled to the public network 112. In an illustrative, non-limiting embodiment, the PEG site 189 can also communicate with a cable head-end via direct link. Video content originating at the PEG site 189 can be captured at the PEG site 189 and can be associated with a web page having a uniform resource locator (URL) at the public network 112. The PEG site 189 can include, for example, a city council meeting site, a legislature site, a classroom or other educational site, a public access television studio, another site related to public information, education, government, or any combination thereof.

In a particular illustrative embodiment, a user can tune a set-top box device, such as the second representative set-top box device 124, to a PEG channel or other public content channel. The set-top box device 124 can initiate a remote desktop protocol (RDP) session or other session by sending a public content channel request to the terminal server 134. The terminal server 134 can determine a uniform resource locator (URL) of a web page associated with the requested channel and can request the URL from the application server 142. For example, the terminal server 134 can launch a web browser to send the URL request to the application server 142. The application server 142 can communicate with the public network 112 via the Internet Mediation Device (IMD) 187 to return the web page having the requested URL.

In an illustrative embodiment, the terminal server 134 can request public video content via the web page returned by the application server 142. For example, the terminal server 134 can request a Windows Media 9 (WM9) stream to be sent to the set-top box device 124. The IMD 187 can receive the video stream from the public network 112 and send the video stream to the set-top box device 124. In an illustrative, non-limiting embodiment, the IMD 187 can inspect the video stream and remove harmful components, such as corrupted data, worms, or viruses, before sending the video content to the set-top box device 124.

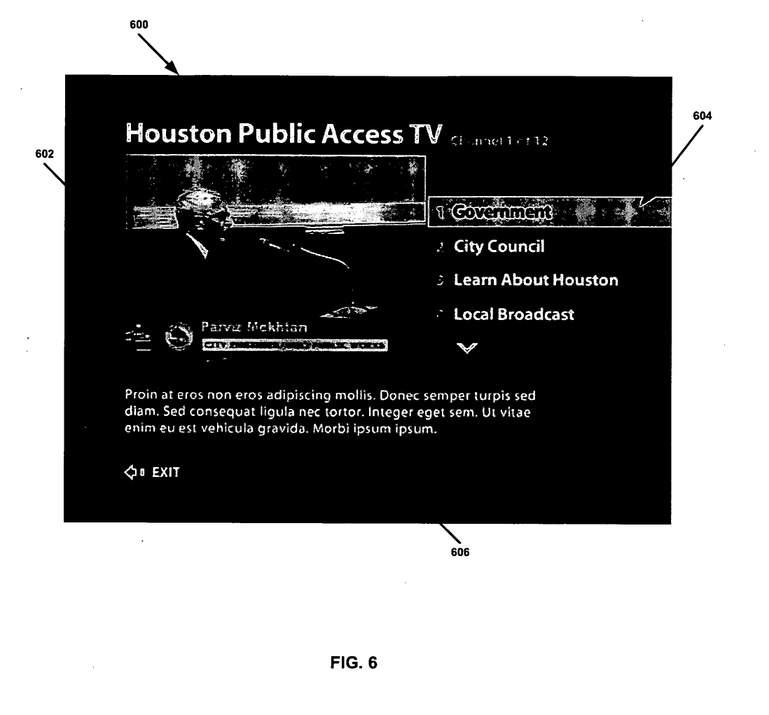

In a particular embodiment, an application interface from the application server 142 can be drawn on the set-top box device 124, and the video content sent by the IMD 187 can be displayed via the application interface. In an illustrative embodiment, the application server 142 can send data or instructions to the set-top box device 124 that are executable by the STB processor 170 to draw the application interface at the television monitor 126. An example of an application interface is illustrated in FIG. 6.

In another particular embodiment, the set-top box device 124 can include a browser, such as a Tasman browser, Trident browser, or other layout engine. When a user tunes the set-top box device 124 to a PEG channel, for example, the set-top box device 124 can open the browser and send a URL request to the application server 142 that includes a URL corresponding to the PEG channel. The application server 142 can communicate with the public network 112 via the Internet Mediation Device (IMD) 187 to return the web page having the requested URL. In an illustrative embodiment, the set-top box device 124 can request public video content via the web page returned by the application server 142. For example, the set-top box device 124 can request a Windows Media 9 (WM9) video stream. The IMD 187 can receive the video stream from the public network 112 and send the video stream to the set-top box device 124. In a particular embodiment, a public application interface from the application server 142 can be drawn on the set-top box device 124, and the video content sent by the IMD 187 can be displayed via the public application interface.

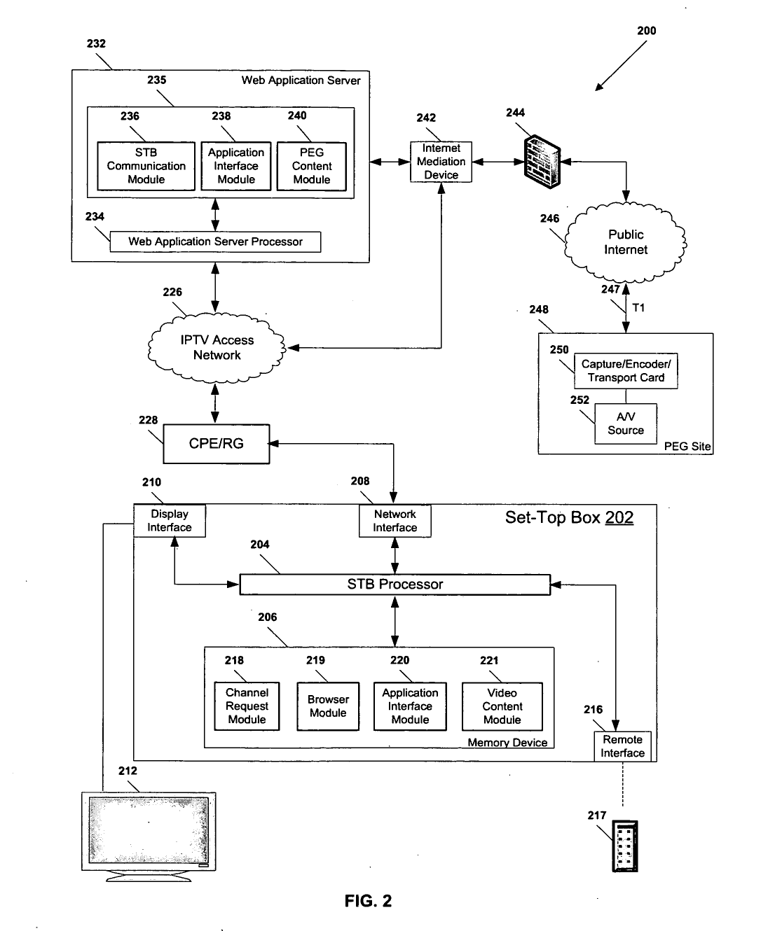

Referring to FIG. 2, a second particular embodiment of a system to provide public video content is illustrated and designated generally at 200. The system 200 includes a set-top box device 202 that communicates with a web application server 232 of an Internet Protocol Television (IPTV) system via an IPTV access network 226. The web application server 232 communicates with the public Internet 246, for example, via an Internet Mediation Device (IMD) 242 and a firewall 244.

In a particular embodiment, a source of publicly generated content, such as the content source 248 can communicate public video content to the public Internet 246. For example, public video content can be filmed or otherwise captured via an audio-visual (A/V) source 252, such as a television camera. The public video content can be encoded by one or more capture and encoding devices, such as the capture/encoder/transport card 250, using a variety of protocols, such as Windows Media 9 (WM9) or H.264, and can be sent to a web host of the public Internet 246 via a T1 line 247 or other transport link. The public video content can be accessed via a web page having a uniform resource locator (URL) associated with a particular public video content channel.

As indicated in FIG. 2, the set-top box device 202 includes a STB processor 204 and a memory device 206 accessible to the STB processor 204. In an illustrative, non-limiting embodiment, the STB processor 204 can communicate with the IPTV access network 226 via the network interface 208. In a particular embodiment, the customer premises equipment (CPE) 228 can facilitate communication between the network interface 208 and the IPTV access network 226. The CPE 228 can include a router, switch, a local area network device, a modem, such as a digital subscriber line (DSL) modem, any other suitable device for facilitating communication between the network interface 208 of the set-top box device 202 and the IPTV access network 226, or any combination thereof. The STB processor 204 can communicate video content to a display device 212 via a display interface 210. In addition, the STB processor 204 can receive commands from a remote control device 217 via a remote interface 216.

In a particular embodiment, the memory device 206 can include a channel request module 218 that is executable by the STB processor 204 to receive channel selections, for instance, from the remote control device 217. The channel request module 218 can be executable by the STB processor 204 to receive a selection of a public video content channel. In a particular embodiment, the memory device 206 can include a browser module 219 that is executable by the STB processor 204 to send a URL request that includes a URL of a web page associated with a selected public video content channel to the web application server 232 via the private access network 226. Further, the browser module 219 can be executable by the STB processor 204 to request public video content, such as a WM9 stream of the public video content, via a web page that is returned by the web application server 232 in response to the URL request.

In a particular embodiment, the memory device 206 can include an application interface module 220 that is executable by the STB processor 204 to communicate with the web application server 232 to receive data to draw an application interface at the display device 212. The application interface can include, for example a video content portion, such as a viewport, and an interactive information portion to display metadata and other interactive content. An example of an application interface is illustrated in FIG. 6.

In a particular embodiment, the memory device 206 can include a video content module 221 that is executable by the STB processor 204 to receive video content via the IPTV access network 226 and to buffer the video content before transmitting it to the display interface 210, in order to prevent underflow to the display device 212. The video content module 221 can be executable by the STB processor 204 to receive video content associated with a requested public video content channel via the IMD 242 and to send the video content to the display device 212 for display via a public content application interface.

As illustrated in FIG. 2, the web application server 232 can include a web application server processor 234 and a web application server memory device 235. The web application server memory device 235 can include a set-top box communication module 236 that is executable by the web application server processor 234 to communicate with the set-top box device 202 to receive a URL request that includes a URL of a web page corresponding to a public video content channel. Further, the web application server memory device 235 can include an application interface module 238 that is executable by the web application server processor 234 to send data to the set-top box device 202 to draw an application interface to display public video content. In an illustrative, non-limiting embodiment, the data can be sent in response to the URL request.

In a particular embodiment, the web application server memory device 235 can include a public video content module 240 that is executable by the web application server processor 234 to communicate with the public Internet 246 via the IMD 242 and the firewall 244 to return a web page corresponding to a URL request received from the set-top box device 202. In an illustrative embodiment, the public video content module 240 can be executable by the web application server processor 234 to instruct the IMD 242 to send video content accessed via the web page to the set-top box device 202.

In an illustrative embodiment, the various modules 218-221 and 236-240 can include logic, hardware, computer instructions, or any combination thereof. In a particular embodiment, the modules 236-240 can be included in a public content software application stored at the web application server.

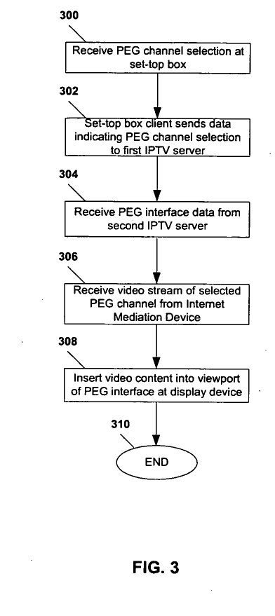

Referring to FIG. 3, a particular illustrative embodiment of a method of providing public video content is illustrated. At block 300, a set-top box device receives a selection of a public content channel, such as a Public Education and Government (PEG) channel, from a remote control device communicating with the set-top box device, for example. Moving to block 302, in a particular embodiment, a set-top box client can send data indicating the public content channel selection to a first server of an Internet Protocol Television (IPTV) system. In an exemplary embodiment, the first IPTV server can be the terminal server 134 of the IPTV system 100 illustrated in FIG. 1.

Proceeding to block 304, in an illustrative embodiment, the set-top box device can receive data from a second server at the IPTV video head-end, such as the application server 142 illustrated in FIG. 1, to draw an application interface at a display device coupled to the set-top box device. In a particular embodiment, the set-top box device can pull or otherwise receive the data from the second server simultaneously with sending data indicating the public content channel selection to the first server. In an alternative embodiment, the set-top box device can pull or otherwise receive the data from the second server after sending data indicating the public content channel selection to the first server. Continuing to block 306, the set-top box device receives a video stream corresponding to the selected public content channel from an Internet Mediation Device of the IPTV system. Advancing to block 308, the set-top box can insert the video content into a viewport or other video content portion of the application interface. The method terminates at 310.

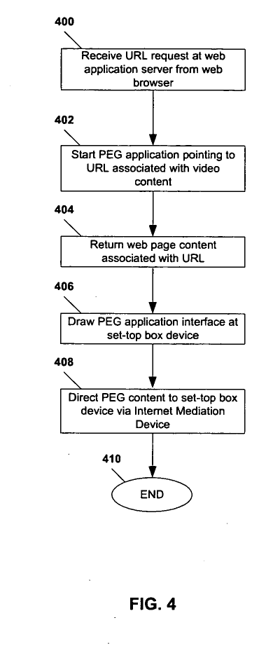

Referring to FIG. 4, a second particular illustrative embodiment of a method of providing public video content is illustrated. At block 400, a web application server of an Internet Protocol Television (IPTV) system receives a URL request from a web browser. The URL request includes a uniform resource locator (URL) of a web page corresponding to a public content channel, such as a Public Education and Government (PEG) channel or other publicly generated content source. In a particular embodiment, the web browser can be running at another server of the IPTV system. In an alternative embodiment, the web browser can be running at a set-top box device communicating with a private access network of the IPTV system.

Moving to block 402, in a particular embodiment, the web application server can start a public content application pointing to the requested URL. At block 404, the web application server returns content associated with the requested URL. In an illustrative embodiment, the content can be web page content. In another embodiment, the content can be interactive content that is not web-based. Proceeding to block 406, in an illustrative embodiment, the web application server can draw an application interface at the set-top box device. At block 408, the web application server can direct video content of the selected public content channel to the set-top box device via an Internet Mediation Device (IMD). In an exemplary embodiment, the set-top box device or another server of the IPTV system can request the video content via the web page, for example, by issuing a Windows Media 9 (WM9) request. The method terminates at 410.

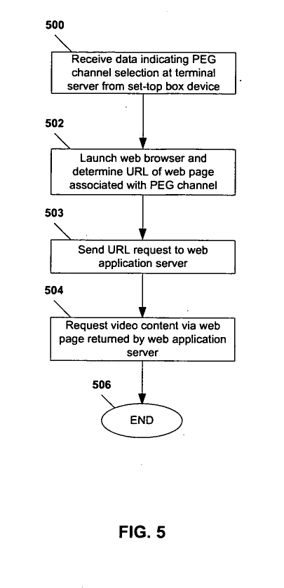

Referring to FIG. 5, a third particular illustrative embodiment of a method of providing public video content is illustrated. At block 500, a terminal server of an Internet Protocol Television (IPTV) system receives data from a set-top box device indicating a selection of a public content channel, such as a Public Education and Government (PEG) channel or other publicly generated content source. Moving to block 502, in a particular embodiment, the terminal server can launch a web browser and determine a URL of a web page associated with the selected PEG channel based on the data received from the set-top box device at block 500. At block 503, the terminal server sends a URL request that includes the determined URL to a web application server via the web browser. Proceeding to block 504, the terminal server requests video content of the PEG channel via a web page returned by the web application server. The method terminates at 506. In an illustrative embodiment, the terminal server, the web application server, or any combination thereof, can instruct the Internet Mediation Device to send the video content to the set-top box device, and the video content can be received by the set-top box device from the Internet Mediation via a private access network of the IPTV system.

In a particular embodiment, the steps of the methods described herein can be executed in the order shown by the figures. In alternative embodiments, some steps can be executed simultaneously or in alternative sequences. For example, the application interface may be drawn at the set-top box device before, after, or concurrently with the web application server returning web page content associated with a requested URL or with the set-top box device issuing a channel request.

Referring to FIG. 6, a particular illustrative embodiment of an application interface to provide public video content is illustrated and designated generally 600. In the embodiment shown, the application interface 600 includes a video content region 602 to display video content of a Public Education and Government (PEG) channel or other publicly generated content source. Further, the application interface 600 can include a plurality of selectable indicators, such as an interactive menu 604, of information related to the video content, the PEG channel, other PEG channels, or any combination thereof. In addition, the application interface 600 includes a text region 606 that can display information selected via the interactive menu 604, closed-captioning text, translation text, or other text related to the video content.

In conjunction with the configuration of structure described herein, the system and method disclosed provide public video content. In a particular illustrative embodiment, content from a Public Education and Government (PEG) source, or another source of publicly generated content, can be fed to the Internet and can be associated with a web page having a uniform resource locator (URL). A user can tune a set-top box device to a PEG channel corresponding to the PEG source, and the set-top box device can send data indicating the PEG channel selection to a first server of an Internet Protocol Television (IPTV) system. The first server can launch a web browser and send a URL request to a second server of the IPTV system. The URL request includes the URL of the web page associated with the PEG source. The second server can communicate with the Internet via an Internet Mediation Device (IMD) to return the web page having the requested URL. In an illustrative embodiment, the terminal server can issue a request via the web page for PEG video content to be delivered to the set-top box device. The IMD can receive the video content from the Internet and send the video content to the set-top box device via a private access network of the IPTV system.

In another particular embodiment, the set-top box device can include a web browser. When a user tunes the set-top box device to a PEG channel, for example, the set-top box device can launch the browser and send the URL request to a web application server of the IPTV system. The web application server can return the web page having the requested URL. In an illustrative embodiment, the set-top box device can request PEG video content via the web page. The IMD can receive the video stream from the Internet and send the video stream to the set-top box device. In a particular embodiment, the web application server can instruct the IMD to deliver the video content to the set-top box device via a private IPTV access network.

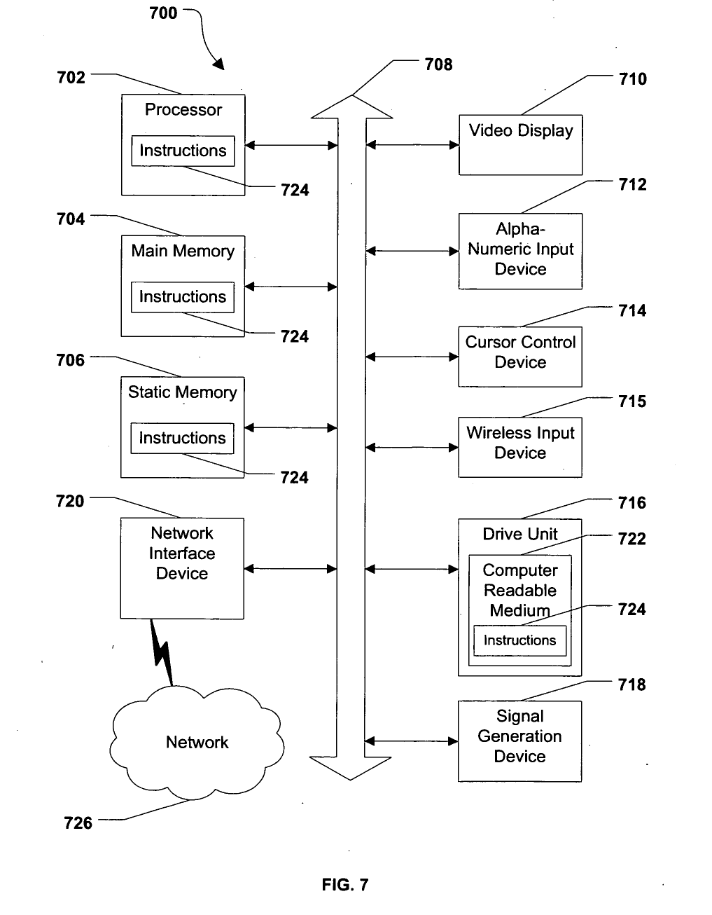

Referring to FIG. 7, an illustrative embodiment of a general computer system is shown and is designated 700. The computer system 700 can include a set of instructions that can be executed to cause the computer system 700 to perform any one or more of the methods or computer based functions disclosed herein. The computer system 700, or any portion thereof, may operate as a standalone device or may be connected, e.g., using a network, to other computer systems or peripheral devices, such as the devices shown in FIGS. 1-2.

In a networked deployment, the computer system may operate in the capacity of a set-top box device, server, Internet Mediation Device, or other device, as illustrated in FIGS. 1-2. The computer system 700 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 700 can be implemented using electronic devices that provide voice, video or data communication. Further, while a single computer system 700 is illustrated, the term “system” shall also be taken to include any collection of systems or sub-systems that individually or jointly execute a set, or multiple sets, of instructions to perform one or more computer functions.

As illustrated in FIG. 7, the computer system 700 may include a processor 702, e.g., a central processing unit (CPU), a graphics-processing unit (GPU), or both. Moreover, the computer system 700 can include a main memory 704 and a static memory 706 that can communicate with each other via a bus 708. As shown, the computer system 700 may further include a video display unit 710, such as a liquid crystal display (LCD), an organic light emitting diode (OLED), a flat panel display, a solid state display, or a cathode ray tube (CRT). Additionally, the computer system 700 may include an input device 712, such as a keyboard, and a cursor control device 714, such as a mouse. Further, the computer system 700 can include a wireless input device 715, e.g., a remote control device. The computer system 700 can also include a disk drive unit 716, a signal generation device 718, such as a speaker or remote control, and a network interface device 720.

In a particular embodiment, as depicted in FIG. 7, the disk drive unit 716 may include a computer-readable medium 722 in which one or more sets of instructions 724, e.g. software, can be embedded. Further, the instructions 724 may embody one or more of the methods or logic as described herein. In a particular embodiment, the instructions 724 may reside completely, or at least partially, within the main memory 704, the static memory 706, and/or within the processor 702 during execution by the computer system 700. The main memory 704 and the processor 702 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 724 or receives and executes instructions 724 responsive to a propagated signal, so that a device connected to a network 726 can communicate voice, video or data over the network 726. Further, the instructions 724 may be transmitted or received over the network 726 via the network interface device 720.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of providing public video content, the method comprising receiving video content of a public video content channel at a set-top box device via a private access network of a video distribution system, wherein the video content is accessible to the video distribution system via a web page associated with the public video content channel.

2. The method of claim 1, wherein the video content is received from the web page via the private access network.

3. The method of claim 1, further comprising receiving a selection of the public video content channel at the set-top box device and sending data indicating the selected public video content channel to a first server of an Internet Protocol Television (IPTV) system.

4. The method of claim 3, wherein the first server sends a uniform resource locator (URL) request that includes a URL of the web page to a second server of the IPTV system and wherein the first server requests the video content via the web page.

5. The method of claim 1, further comprising wherein the set-top box device requests the video content via the web page.

6. The method of claim 5, further comprising:
launching a web browser at the set-top box device; and
issuing a uniform resource locator (URL) request that includes a URL of the web page to a web application server of the video distribution system, wherein the web application server retrieves the web page from the Internet via an Internet Mediation Device.

7. The method of claim 6, wherein the set-top box device receives the video content from the web page via the Internet Mediation Device.

8. The method of claim 6, further comprising receiving data at the set-top box device from the web application server to draw an application interface at a display device coupled to the set-top box device, wherein the video content is displayed via a video content portion of the application interface.

9. A method of providing public video content, the method comprising:
receiving data indicating a selection of a public video content channel from a set-top box device at a first server of an Internet Protocol Television (IPTV) system; and
requesting video content of the public video content channel via a web page associated with the public video content channel, wherein the video content is communicated to the set-top box from the web page.

10. The method of claim 9, further comprising issuing a uniform resource locator (URL) request to a second server of the IPTV system via a web browser, wherein the URL request includes a URL of the web page and wherein the second server returns the web page.

11. The method of claim 10, further comprising determining the URL based on the data indicating the selection of the public video content channel.

12. The method of claim 10, further comprising requesting the video content via the web page.

13. A method of providing public video content, the method comprising:
receiving a uniform resource locator (URL) request at a web application server of an Internet Protocol Television (IPTV) system, the URL request indicating a URL of a web page associated with a public video content channel; and
retrieving the web page via a public data network, wherein the video content of the public video content channel is targeted for communication from the web page to a set-top box device via a private access network of the IPTV system.

14. The method of claim 13, wherein the URL request is received from a web browser at another server of the IPTV system.

15. The method of claim 13, wherein the URL request is received from a web browser at the set-top box device.

16. The method of claim 13, further comprising launching a public video content application at the web application server after receiving the URL request.

17. The method of claim 13, wherein the web application server retrieves the web page via an Internet Mediation Device, and wherein the set-top box device receives the video content via the Internet Mediation Device.

18. A set-top box device, comprising a processor and a memory device accessible to the processor, wherein the memory device stores instructions executable by the processor to communicate with a private access network of an Internet Protocol Television (IPTV) system to receive video content of a public video content channel, wherein the video content is accessible to the IPTV system via a web page associated with the public video content channel.

19. The set-top box device of claim 18, wherein the memory device stores instructions executable by the processor to launch a web browser in response to a selection of the public video content channel and to send a URL request to a web application server of the IPTV system, the request including a uniform resource locator (URL) of the web page.

20. The set-top box device of claim 19, wherein the web browser is a Tasman browser.

21. The set-top box device of claim 20, wherein the memory device stores instructions to request video content via the web page and to communicate with an Internet Mediation Device of the IPTV system to receive the video content.

22. The set-top box device of claim 21, wherein the memory device stores instructions to communicate with the web application server to receive data to draw an application interface at a display device coupled to the set-top box device, and to display the video content and text related to the video content via the application interface.

23. A computer-readable medium tangibly embodying a set of instructions that are executable by a processor to:
receive a uniform resource locator (URL) request at a first device of a video distribution system, the URL request including a URL of a web page associated with a public video content channel; and
retrieve the web page via a public data network, wherein the video content of the public video content channel is communicated from the web page to a set-top box device via a private access network of the video distribution system.

24. The computer-readable medium of claim 23, further comprising instructions executable by the processor to direct an Internet Mediation Device to send the video content to the set-top box device via a private access network of the video distribution system.

25. The computer-readable medium of claim 23, further comprising instructions to send data to draw an application interface to the set-top box device after receiving the URL request.

26. The computer-readable medium of claim 25, wherein the application interface includes a viewport to display the video content and a text region to display text information selected by a user.

27. The computer-readable medium of claim 26, wherein the text information includes metadata related to the video content.

28. The computer-readable medium of claim 23, wherein the public video content channel includes a Public Education and Government (PEG) channel.
